(19) United States
(12) Patent Application Publication
(10) Pub. No.: US 2020/0040945 A1
(43) Pub. Date: Feb. 6, 2020

(54) RADIAL ROLLER BEARING CAGE

(71) Applicant: JTEKT CORPORATION, Osaka (JP)

(72) Inventor: Kotaro YAMASHITA, Kashiwara-shi (JP)

(73) Assignee: JTEKT CORPORATION, Osaka (JP)

(21) Appl. No.: 16/504,436

(22) Filed: Jul. 8, 2019

(30) Foreign Application Priority Data
Aug. 3, 2018 (JP) 2018-146584

(51) Int. Cl. F16C 33/66; F16C 33/46

(52) U.S. Cl. CPC F16C 33/6681; F16C 19/463; F16C 33/467

(57) ABSTRACT

A radial roller bearing cage made of metal includes annular rim portions; and a retaining portion including cage bars. Each of the cage bars includes a body portion connecting the rim portions to each other, and projected portions. On an outer peripheral side of the retaining portion, at least a portion of an outer surface of the body portion is a curved surface having the same diameter as a diameter of an outer peripheral surface of each of the rim portions. In an outer surface of each of the projected portions on the outer peripheral side of the retaining portion, at least a portion on a distal end side in a projected direction is located radially inward of the outer peripheral surface of each of the rim portions.

### INCORPORATION BY REFERENCE

The disclosure of Japanese Patent Application No. 2018-146584 filed on Aug. 3, 2018 including the specification, drawings and abstract is incorporated herein by reference in its entirety.

### BACKGROUND

### 1. Technical Field

The disclosure relates to a radial roller bearing cage provided with a plurality of pockets, each of which retains a roller such that the roller is rollable.

### 2. Description of Related Art

A radial roller bearing having a plurality of rollers has been used to support a planetary gear in a planetary gear mechanism, for example. In such a radial roller bearing, a cage for retaining the rollers includes a pair of annular rim portions and a plurality of cage bars. The rim portions are concentrically disposed so as to be away from each other in an axial direction. The cage bars are provided between the rim portions at equally-spaced intervals in a circumferential direction. Pockets are provided among the cage bars, and the rollers are respectively retained in the pockets so as to be rollable. In addition, on an outer peripheral side of the cage, an end portion of each of the cage bars is provided with a projection (retaining projection) to prevent the roller from coming off from the pocket.

An outer surface of each of the retaining projections on the outer peripheral side of the cage and an outer surface of a portion, which is provided with the retaining projection, in each of the cage bars are curved surfaces that are continuous with an outer peripheral surface of each of the rim portions, and curvature radii of such outer surfaces are the same as a radius of each of the rim portions. The outer peripheral surfaces of the rim portions and each of the above outer surfaces slide on an inner peripheral surface of a support target such as the planetary gear when the cage becomes eccentric with respect to the support target.

### SUMMARY

In the radial roller bearing that is configured as described above, a lubricant is used to suppress wear of sliding portions between the rollers and the cage and a sliding portion between the cage and the support target. However, depending on use situations related to a rotational speed of the support target and a surface pressure of each of the sliding portions, there is a case where the lubricant is not sufficiently supplied to each of the sliding portions, and, as a result, the wear is accelerated.

In view of the above circumstance, the disclosure provides a radial roller bearing cage capable of suppressing wear of sliding portions by increasing a supply amount of a lubricant to the sliding portions.

An aspect of the disclosure relates to a radial roller bearing cage made of metal. The radial roller bearing cage includes a pair of rim portions concentrically disposed so as to be away from each other in an axial direction, each of the rim portions having an annular shape; and a retaining portion that includes a plurality of cage bars provided between the rim portions at equally-spaced intervals in a circumferential direction. Pockets are provided among the cage bars, and a plurality of rollers are respectively retained in the pockets so as to be rollable. Each of the cage bars includes a body portion connecting the rim portions to each other, and projected portions each of which is projected from an inner surface of a corresponding one of the pockets in the body portion to prevent the roller from coming off from the corresponding one of the pockets. On an outer peripheral side of the retaining portion, at least a portion of an outer surface of the body portion is a curved surface having the same diameter as a diameter of an outer peripheral surface of each of the rim portions. In an outer surface of each of the projected portions on the outer peripheral side of the retaining portion, at least a portion on a distal end side in a projected direction is located radially inward of the outer peripheral surface of each of the rim portions.

The radial roller bearing cage according to the above aspect of the disclosure can suppress wear of sliding portions by increasing a supply amount of a lubricant to the sliding portions.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is an exploded perspective view of a planetary gear mechanism using a radial roller bearing according to a first embodiment of the disclosure;

FIG. 2 is a side view of the radial roller bearing disposed between a planetary gear and a support shaft as viewed in an axial direction;

FIG. 3 is a perspective view of the radial roller bearing;

FIG. 4 is a cross-sectional view of the radial roller bearing, showing a cross section perpendicular to the axial direction;

FIG. 5A and FIG. 5B are enlarged cross-sectional views of a portion of the radial roller bearing, FIG. 5A shows a state where a cage of the radial roller bearing is disposed concentrically with the planetary gear, and FIG. 5B shows a state where the cage of the radial roller bearing is eccentric with respect to the planetary gear,

FIG. 6A and FIG. 6B are enlarged cross-sectional views of a portion of a radial roller bearing according to related art, FIG. 6A shows a state where a cage of the radial roller bearing is disposed concentrically with the planetary gear, and FIG. 6B shows a state where the cage of the radial roller bearing is eccentric with respect to the planetary gear;

FIG. 7 is an enlarged cross-sectional view of a portion of a radial roller bearing according to a modified embodiment of the first embodiment of the disclosure;

FIG. 8 is an enlarged cross-sectional view of a portion of a radial roller bearing according to a second embodiment of the disclosure; and

FIG. 9 is an enlarged cross-sectional view of a portion of a radial roller bearing according to a third embodiment of the disclosure.

### DETAILED DESCRIPTION OF EMBODIMENTS

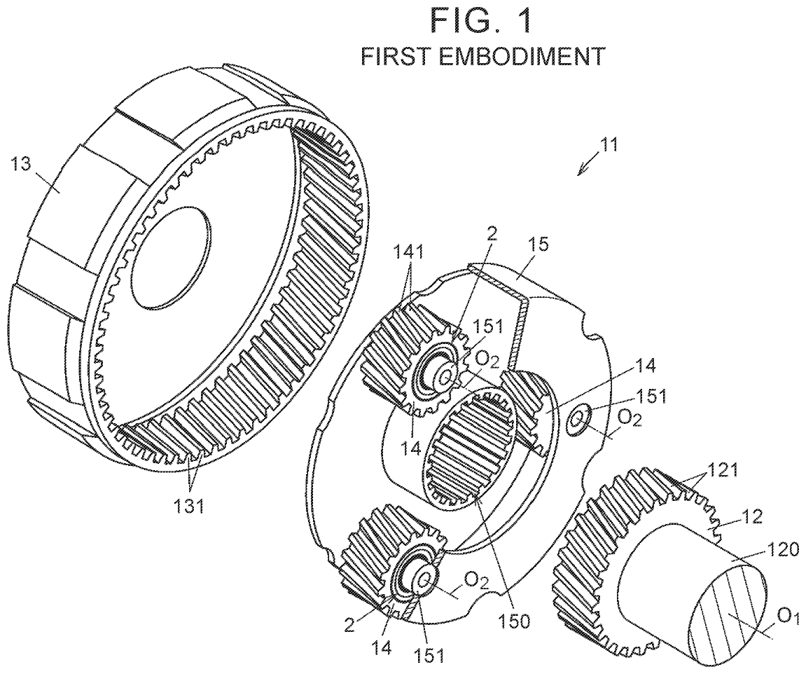

A description will hereinafter be made on a first embodiment of the disclosure with reference to FIG. 1 to FIG. 5. Note that embodiments described below are specific examples for implementing the disclosure and specifically exemplifies various technical matters. However, the technical scope of the disclosure is not limited to the embodiments.

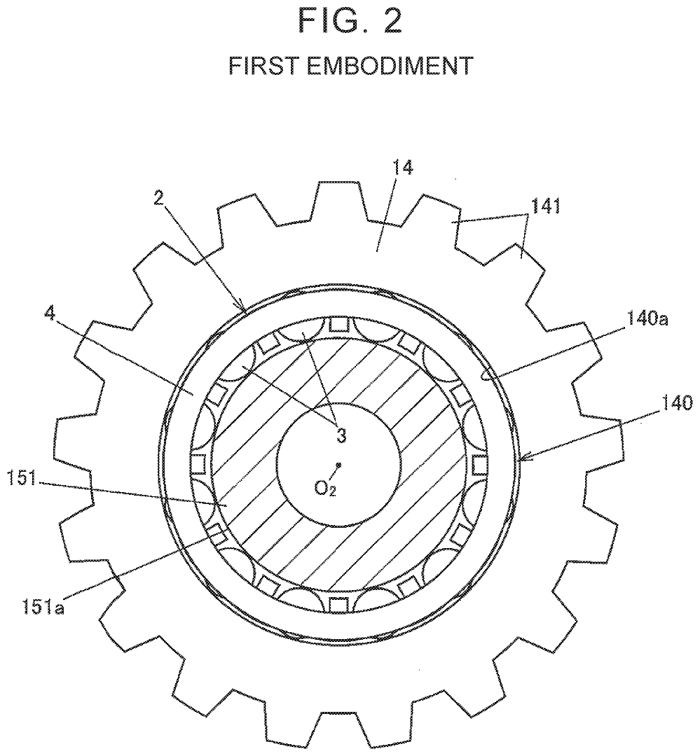

An overall configuration of a planetary gear mechanism will be described. FIG. 1 is an exploded perspective view of the planetary gear mechanism using a radial roller bearing according to this embodiment. FIG. 2 is a side view of the radial roller bearing disposed between a planetary gear in the planetary gear mechanism and a support shaft as viewed in an axial direction.

A planetary gear mechanism 11 includes a sun gear 12 having external teeth 121 on an outer peripheral surface; an internal gear 13 having internal teeth 131 on an inner peripheral surface; a plurality of (three in this embodiment) planetary gears 14, each of which has external teeth 141 on an outer peripheral surface, is disposed between the sun gear 12 and the internal gear 13, and meshes with the external teeth 121 and the internal teeth 131; and a carrier 15 having cylindrical support shafts 151, each of which is inserted through a corresponding one of the planetary gears 14.

Such a planetary gear mechanism 11 is used in a transmission that changes a rotational speed of an output shaft (crankshaft) of an engine serving as a drive source of an automobile, for example. Of three elements including the sun gear 12, the internal gear 13, and the carrier 15, one element is fixed in a nonrotatable manner, and another element receives torque. Consequently, the received torque, which is reduced or increased, is transmitted to the remaining element. A lubricant (for example, transmission oil) lubricates each component of the planetary gear mechanism 11 for sliding.

A shaft 120 is fixed to a center portion of the sun gear 12 such that the shaft 120 is not rotatable relative to the sun gear 12, and the sun gear 12 is disposed concentrically with the internal gear 13 and the carrier 15. The support shaft 151 is inserted through a shaft hole 140 (see FIG. 2) extending through a center portion of each of the planetary gears 14. A radial roller bearing 2 according to this embodiment is disposed between an outer peripheral surface 151a of the support shaft 151 and an inner peripheral surface 140a of the shaft hole 140 in the planetary gear 14, so as to smoothen rotation of the planetary gear 14 with respect to the support shaft 151.

For example, in the case where the internal gear 13 is fixed to a transmission case in the nonrotatable manner and the shaft 120 rotates, rotation of the sun gear 12 that rotates with the shaft 120 is decelerated and is then output to an output shaft, which is not shown and spline-fitted to a center hole 150 of the carrier 15. At this time, each of the planetary gears 14 revolves around a rotation axis O₁ of the shaft 120 and rotates about a center axis O₂ of the support shaft 151.

The radial roller bearing 2 is configured to include a plurality of columnar rollers 3 and a metallic cage 4, and supports the rotation of the planetary gear 14 while receiving a centrifugal force that is generated by the revolution of the planetary gear 14. In this embodiment, the twelve rollers 3 are retained at equally-spaced intervals in the cage 4.

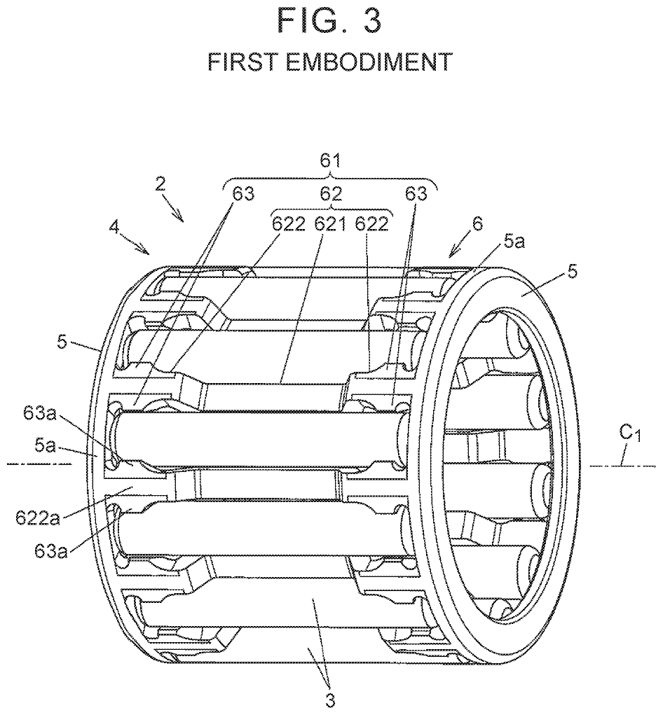

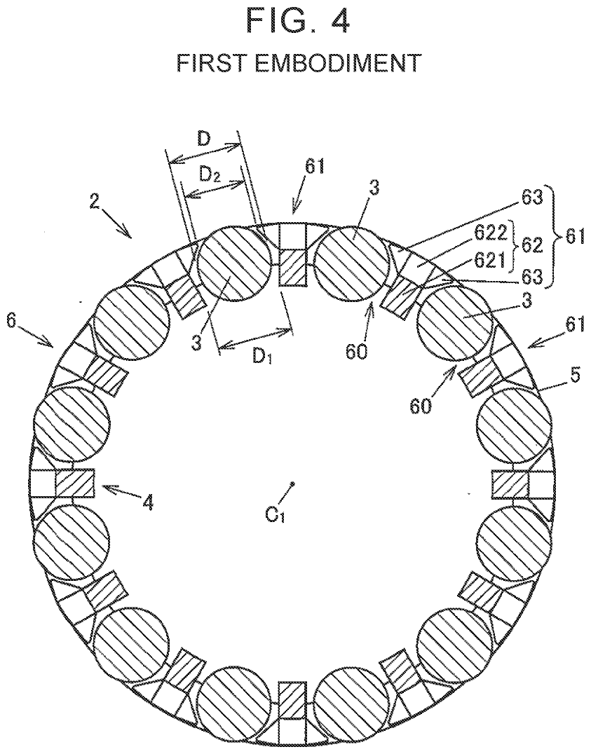

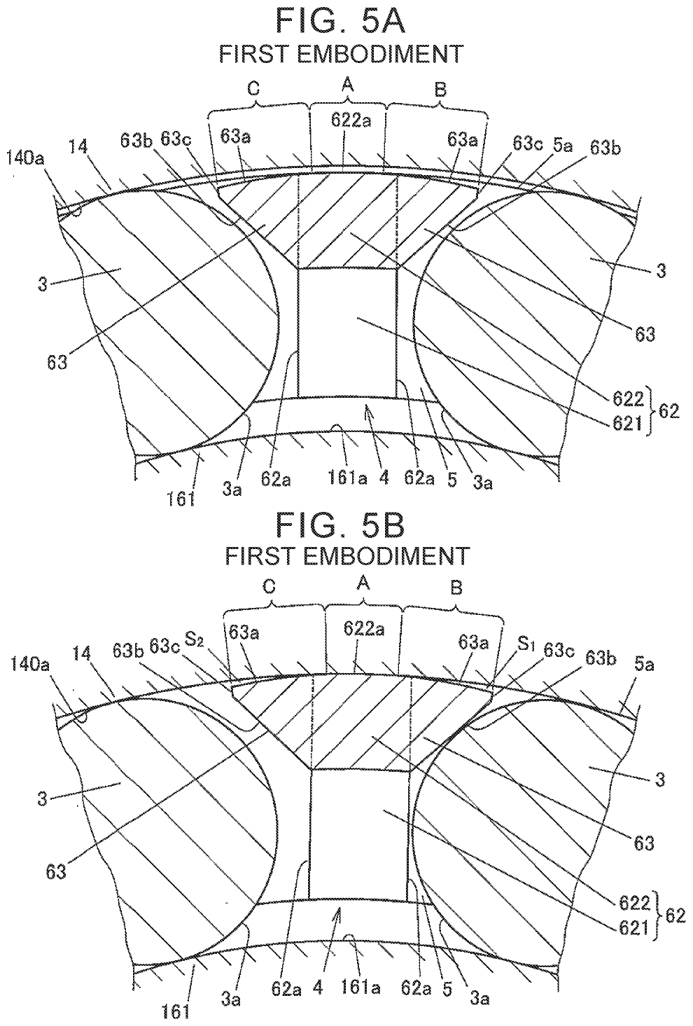

A configuration of the radial roller bearing 2 will be described. FIG. 3 is a perspective view of the radial roller bearing 2. FIG. 4 is a cross-sectional view of the radial roller bearing 2, showing a cross section perpendicular to the axial direction. FIG. 3 and FIG. 4 each show a center axis C₁ of the cage 4. FIG. 5A and FIG. 5B are enlarged cross-sectional views of a portion of the radial roller bearing 2, FIG. 5A shows a state where the center axis C₁ of the cage 4 matches the center axis O₂ of the support shaft 151, and FIG. 5B shows a state where the cage 4 is eccentric with respect to the support shaft 151 and a portion of an outer peripheral surface of the cage 4 is in contact with the inner peripheral surface 140a of the shaft hole 140 in the planetary gear 14.

The cage 4 integrally includes a pair of annular rim portions 5 and a retaining portion 6. The rim portions 5 are concentrically disposed so as to be away from each other in the axial direction. The retaining portion 6 includes a plurality of cage bars 61 provided between the rim portions 5 at equally-spaced intervals in a circumferential direction. As a material of the cage 4, iron-based metal such as SCM 415 or SPC may be used. The retaining portion 6 is formed to be cylindrical as a whole, and is provided with pockets 60. The rollers 3 are respectively retained in the pockets 60 so as to be rollable. The pockets 60 are provided among the cage bars 61 in the retaining portion 6. More specifically, each of the pockets 60 is provided between the cage bars 61 adjacent to each other. The rollers 3 roll on the outer peripheral surface 151a of the support shaft 151 and the inner peripheral surface 140a of the shaft hole 140 in the planetary gear 14.

Each of the cage bars 61 includes a body portion 62 connecting the rim portions 5 to each other, and projected portions 63 each of which prevents the roller 3 from coming off from the pocket 60. Each of the projected portions 63 is projected in a circumferential direction of the retaining portion 6 from a corresponding one of mutually facing surfaces 62a of the body portions 62 of two of the cage bars 61 adjacent to each other. Each of the facing surfaces 62a is a side surface of the body portion 62, which forms an inner surface of the pocket 60, and the projected portion 63 is projected from each of the facing surfaces 62a on both sides of the body portion 62 in the circumferential direction.

In the body portion 62, a longitudinal center portion (i.e., a center portion in a longitudinal direction) 621 along the axial direction of the retaining portion 6 is located radially inward of both of end portions 622 in the longitudinal direction. The projected portions 63 are provided in each of the end portions 622. That is, the single cage bar 61 is provided with the four projected portions 63. FIG. 4 shows a cross section of the cage 4 including the center portions 621. FIG. 5A and FIG. 5B each show a cross section of the cage 4 including the end portion 622.

As shown in FIG. 4, a distance D₁ between the body portions 62 (the center portions 621) and a distance D₂ between the projected portions 63 of two of the cage bars 61 adjacent to each other are less than a diameter D of the roller 3. In this way, each of the rollers 3 is restrained from coming off radially inward or outward from the retaining portion 6. Note that, during production of the radial roller bearing 2, the cage bars 61 are elastically deformed to increase the distance D₁, and each of the rollers 3 is disposed in the pocket 60 from the inside of the retaining portion 6.

On the outer peripheral side of the retaining portion 6, at least a portion of an outer surface 622a of each of the end portions 622 in the body portion 62 is formed to be a curved surface having the same diameter as the diameter of an outer peripheral surface 5a of each of the rim portions 5, which is centered on the center axis C₁, and is continuous with the outer peripheral surface 5a of each of the rim portions 5. In this embodiment, as shown in FIG. 5A and FIG. 5B, a first partial region A which is a part of a center portion, in a width direction (the circumferential direction of the retaining portion 6), of the outer surface 622a of the body portion 62 is formed to be the curved surface having the same diameter as the diameter of the outer peripheral surface 5a of the rim portion 5.

In addition, FIG. 5A and FIG. 5B show two partial regions on respective sides of the first partial region A in the circumferential direction of the retaining portion 6 in the cage bar 61, as a second partial region B and a third partial region C. Both end portions, in the width direction, of the outer surface 622a in the body portion 62 and outer surfaces 63a of the projected portions 63 on the outer peripheral side of the retaining portion 6 are included in the second and third partial regions B, C.

In each of the second and third partial regions B, C, the end portion of the outer surface 622a of the body portion 62 and the outer surface 63a of the projected portion 63 are curved surfaces having smaller curvature radii than a curvature radius of the first partial region A. The end portion of the outer surface 622a of the body portion 62 and the outer surface 63a of the projected portion 63 are located radially inward of the outer peripheral surface 5a of the rim portion 5 (in other words, the end portion of the outer surface 622a of the body portion 62 and the outer surface 63a of the projected portion 63 are located closer to the center axis C₁ than the outer peripheral surface 5a of the rim portion 5 is). The outer surfaces 622a of the body portions 62 and the outer surfaces 63a of the projected portions 63 constitute the outer peripheral surface of the cage 4, and the outer peripheral surface of the cage 4 smoothly continues without steps in each boundary between the first partial region A and each of the second and third partial regions B, C. In addition, the part of the center portion of the outer surface 622a of the body portion 62 in the first partial region A and the outer peripheral surface 5a of the rim portion 5 are subjected to polishing processing and thus are polished surfaces.

In this embodiment, the entire outer surface 63a of the projected portion 63 is included in each of the second and third partial regions B, C, and is located radially inward of the outer peripheral surface 5a of the rim portion 5. In addition, in this embodiment, in an outer surface of the body portion 62, a portion that is positioned between the first partial region A and the outer surface 63a of the projected portion 63 is located radially inward of the outer peripheral surface 5a of the rim portion 5. That is, a portion (the end portion in the width direction) of the outer surface 622a of the body portion 62 in each of the second and third partial regions B, C is located radially inward of the outer peripheral surface 5a of the rim portion 5.

As shown in FIG. 5B, when the cage 4 is eccentric with respect to the support shaft 151, the portion (a center portion in the width direction) of the outer surface 622a of the body portion 62 in the first partial region A and the outer peripheral surface 5a of the rim portion 5 come in contact with the inner peripheral surface 140a of the shaft hole 140 in the planetary gear 14. In this way, compared to a case where only the outer peripheral surface 5a of the rim portion 5 comes in contact with the inner peripheral surface 140a of the shaft hole 140, a contact surface pressure with the inner peripheral surface 140a of the shaft hole 140 is reduced. Meanwhile, in the second and third partial regions B, C, spaces S₁, S₂ are formed between the inner peripheral surface 140a of the shaft hole 140 and a combination of both of the end portions in the width direction of the outer surface 622a of the body portion 62 and the outer surfaces 63a of the projected portions 63. Each of these spaces S₁, S₂ functions as an oil basin where the lubricant is retained.

As shown in FIG. 5B, when the cage 4 is eccentric and rotates with respect to the support shaft 151, an outer peripheral surface 3a of each of the rollers 3 slidingly contacts an inclined surface 63b of the projected portion 63. The inclined surface 63b of the projected portion 63 is a surface that defines an obtuse angle with a side surface (the facing surface 62a) of the body portion 62 and is inclined with respect to the radial direction of the retaining portion 6. A top of the projected portion 63 in a projected direction is chamfered, and a chamfered surface 63c is formed between the outer surface 63a and the inclined surface 63b of the projected portion 63.

When the cage 4 is eccentric and rotates with respect to the support shaft 151 in conjunction with the rotation of the planetary gear 14, the lubricant, which is retained in each of the spaces S₁, S₂, is supplied to a sliding portion between the center portion of the outer surface 622a of the body portion 62 in the first partial region A and the inner peripheral surface 140a of the shaft hole 140 and to a sliding portion between the inclined surface 63b of the projected portion 63 and the outer peripheral surface 3a of the roller 3. In this way, wear of these sliding portions is suppressed.

A method for manufacturing the cage 4 will be described. The cage 4 is manufactured through a pressing process to press a flat steel sheet so as to obtain a ladder-shaped body, a curling process to curl this shaped body in a ring shape by plastic deformation, and a polishing process to polish the outer surface 622a of the body portion 62 in each of the first partial regions A and the outer peripheral surface 5a of each of the rim portions 5 after the curling process. The ladder-shaped body integrally includes a pair of straight rod body portions and a plurality of columnar body portions. The rod body portions are parallel with each other. Each of the columnar body portions connects these rod body portions in a perpendicular direction to the longitudinal direction of the rod body portion. The rod body portions are curled in the curling process to become the pair of rim portions 5, and each of the columnar body portions becomes the cage bar 61. Both ends of each of the rod body portions are joined to each other by welding, for example. Portions to be the second and third partial regions B, C are pressed to be dented from a portion to be the first partial region A in the pressing process, and are located radially inward of the outer peripheral surface 5a of each of the rim portions 5 in the curling process.

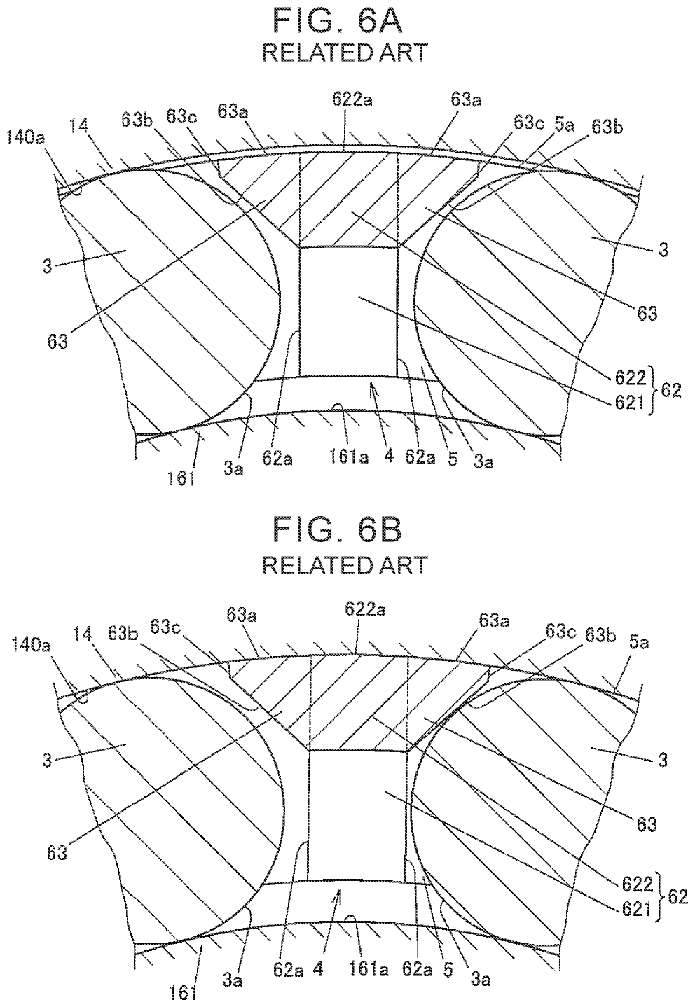

The related art will be described. FIG. 6A and FIG. 6B are enlarged cross-sectional views of a portion of a radial roller bearing according to the related art, FIG. 6A shows a state where the cage 4 is disposed coaxially with the planetary gear 14, and FIG. 6B shows a state where the cage 4 is eccentric with respect to the planetary gear 14. In this related art, the outer surface 622a of the body portion 62 and the outer surface 63a of each of the projected portions 63 in each of the cage bars 61 are formed in a similar manner to those in the first embodiment except for a point that the outer surface 622a and the outer surface 63a are each formed to be the curved surface having the same diameter as the diameter of the outer peripheral surface 5a of the rim portion 5. Thus, in FIG. 6A and FIG. 6B, portions corresponding to the components of the radial roller bearing 2 according to the first embodiment are denoted by the same reference numerals and symbols as those in FIG. 5A and FIG. 5B, and the description thereon will not be made.

In this related art, as described above, the outer surface 622a of the body portion 62 and the outer surface 63a of each of the projected portions 63 are each formed to be the curved surface having the same diameter as the diameter of the outer peripheral surface 5a of the rim portion 5. Thus, when the cage 4 is eccentric with respect to the support shaft 151, a space for retaining the lubricant is not formed between the inner peripheral surface 140a of the shaft hole 140 in the planetary gear 14 and the combination of the outer surface 622a of the body portion 62 and the outer surface 63a of the projected portion 63. Accordingly, the wear and heat generation, which are caused by a lack of the lubricant, are likely to occur on the outer surfaces 622a of the body portions 62 and the outer surfaces 63a of the projected portions 63 on a rear side in a rotational direction of the cage 4. In addition, because a small amount of the lubricant is supplied to the sliding portion between the inclined surface 63b of each of the projected portions 63 and the outer peripheral surface 3a of each of the rollers 3, the wear and the heat generation are likely to occur on this sliding portion.

Operation and effects of the first embodiment will be described. In the radial roller bearing 2 according to the first embodiment, the end portions of the outer surface 622a of the body portion 62 and the entire outer surface 63a of each of the projected portions 63 in each of the cage bars 61 are located radially inward of the outer peripheral surface 5a of the rim portion 5. Thus, even when the cage 4 is eccentric with respect to the support shaft 151, each of the spaces S₁, S₂ for retaining the lubricant is formed between the inner peripheral surface 140a of the shaft hole 140 and the combination of the outer surface 622a and the outer surfaces 63a. In this way, the sliding portion between the center portion of the outer surface 622a of the body portion 62 and the inner peripheral surface 140a of the shaft hole 140 and the sliding portion between the inclined surface 63b of the projected portion 63 and the outer peripheral surface 3a of the roller 3 are lubricated by the lubricant. Thus, the wear and the heat generation of these sliding portions are suppressed.

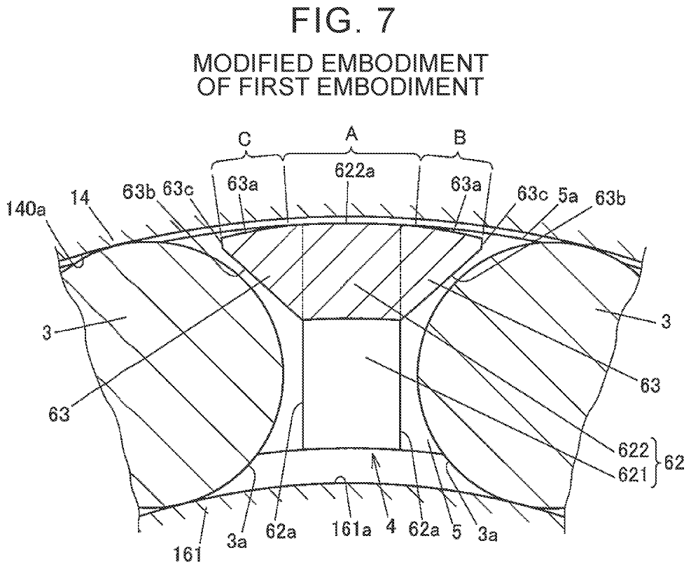

A modified embodiment of the first embodiment will be described. FIG. 7 is an enlarged cross-sectional view of a portion of a radial roller bearing according to the modified embodiment of the first embodiment. In the first embodiment shown in FIG. 5A, FIG. 5B, and the like, the description has been made on the case where the first partial region A, which is formed in the curved surface having the same diameter as the diameter of the outer peripheral surface 5a of the rim portion 5, is provided in the center portion, in the width direction, of the outer surface 622a of the body portion 62 and the case where each of the second and third partial regions B, C, which are located radially inward of the outer peripheral surface 5a of the rim portion 5, is provided in the end portion of the outer surface 622a of the body portion 62 and the entire outer surface 63a of the projected portion 63. Meanwhile, in the modified embodiment shown in FIG. 7, the first partial region A is formed of the entire outer surface 622a of the body portion 62 and a portion on the body portion 62-side of the outer surface 63a of the projected portion 63 (i.e., a portion of the outer surface 63a, the portion being located on the side of the body portion 62), and each of the second and third partial regions B, C is provided only in a distal end of the projected portion 63 in the projected direction (in other words, a direction in which the projected portion 63 is projected, i.e., the circumferential direction of the retaining portion 6).

Also, in such a modified embodiment, when the cage 4 is eccentric with respect to the support shaft 151, a space for retaining the lubricant is formed between the inner peripheral surface 140a of the shaft hole 140 in the planetary gear 14 and the outer surface 63a of the projected portion 63 in each of the second and third partial regions B, C. Thus, the wear and the heat generation of each of the sliding portions are suppressed. That is, in the outer surface 63a of the projected portion 63, at least the portion on the distal end side in the projected direction may be located radially inward of the outer peripheral surface 5a of each of the rim portions 5. In addition, according to such a modified embodiment, when the cage 4 is eccentric, it is possible to obtain a large contact area between the inner peripheral surface 140a of the shaft hole 140 and the outer peripheral surface of the cage 4 including the outer peripheral surface 5a of the rim portion 5 and the outer surface 622a of the body portion 62 in the cage bar 61. Thus, a surface pressure on this contact surface can be reduced, and the cage 4 can rotate smoothly.

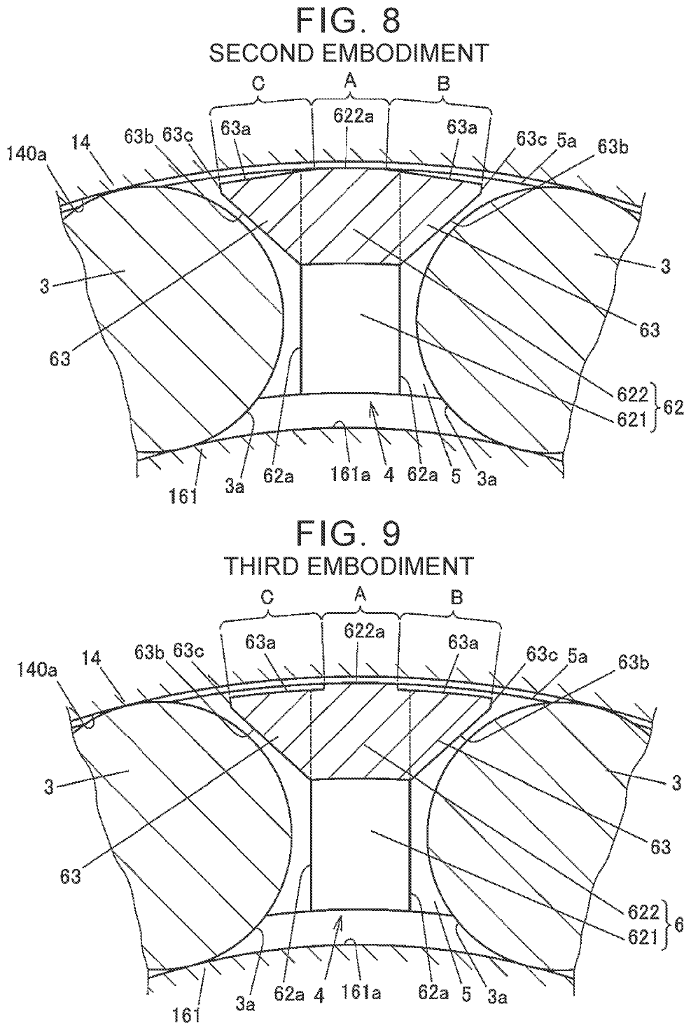

A description will hereinafter be made on a second embodiment of the disclosure with reference to FIG. 8. In the first embodiment, the description has been made on the case where the end portions of the outer surface 622a of the body portion 62 and the outer surface 63a of the projected portion 63 in the cage bar 61 in each of the second and third partial regions B, C are the curved surfaces having the smaller curvature radii than the curvature radius of the first partial region A (the curvature radius of the outer peripheral surface 5a of the rim portion 5). In this embodiment, the end portions of the outer surface 622a of the body portion 62 and the outer surface 63a of the projected portion 63 in the cage bar 61 in each of the second and third partial regions B, C are formed to be flat surfaces (linear in a cross section shown in FIG. 8). In each of the second and third partial regions B, C, the end portions of the outer surface 622a of the body portion 62 and the outer surface 63a of the projected portion 63 in the cage bar 61 are located radially inward of the outer peripheral surface 5a of the rim portion 5. When the cage 4 is eccentric with respect to the support shaft 151, a space for retaining the lubricant is formed between the inner peripheral surface 140a of the shaft hole 140 and the combination of the end portion of the outer surface 622a of the body portion 62 and the outer surface 63a of the projected portion 63 in the cage bar 61 in each of the second and third partial regions B, C. In this way, the same operation and the same effects as those in the first embodiment are obtained.

Next, a description will be made on a third embodiment of the disclosure with reference to FIG. 9. In this embodiment, in each of the second and third partial regions B, C, the end portion of the outer surface 622a of the body portion 62 and the outer surface 63a of the projected portion 63 in the cage bar 61 are located radially inward of the outer peripheral surface 5a of the rim portion 5 via a small step from the first partial region A. In other words, the small step is provided between the first partial region A and the end portion of the outer surface 622a of the body portion 62 in each of the second and third partial regions B, C. In a cross section shown in FIG. 9, the end portion of the outer surface 622a of the body portion 62 and the outer surface 63a of the projected portion 63 in the cage bar 61 in each of the second and third partial regions B, C have an arcuate shape around the center axis C₁ of the cage 4.

Also, in this embodiment, similarly to the first and second embodiments, when the cage 4 is eccentric with respect to the support shaft 151, the space for retaining the lubricant is formed. In this way, the same operation and the same effects as those in the first embodiment are obtained.

The description has been made so far on the basis of the first to third embodiments. However, these embodiments do not limit the disclosure according to the claims. In addition, it should be noted that not all of the combinations of the characteristics described in the embodiments may be essential for solving the problem of the disclosure.

The disclosure can be appropriately modified for implementation within the scope that does not depart from the disclosure. For example, in the second embodiment or the third embodiment, as in the modified embodiment of the first embodiment described with reference to FIG. 7, the first partial region A may extend to the portion on the body portion 62-side of the outer surface 63a of the projected portion 63. Alternatively, the entire outer surface 622a of the body portion 62 may be set as the first partial region A, and the entire outer surfaces 63a of the projected portions 63, each of which is projected from this body portion 62, may be set as the second and third partial regions B, C.

What is claimed is:

1. A radial roller bearing cage made of metal, the radial roller bearing cage comprising:
a pair of rim portions concentrically disposed so as to be away from each other in an axial direction, each of the rim portions having an annular shape; and
a retaining portion that includes a plurality of cage bars provided between the rim portions at equally-spaced intervals in a circumferential direction, wherein
pockets are provided among the cage bars, and a plurality of rollers are respectively retained in the pockets so as to be rollable,
each of the cage bars includes a body portion connecting the rim portions to each other, and projected portions each of which is projected from an inner surface of a corresponding one of the pockets in the body portion to prevent the roller from coming off from the corresponding one of the pockets,
on an outer peripheral side of the retaining portion, at least a portion of an outer surface of the body portion is a curved surface having the same diameter as a diameter of an outer peripheral surface of each of the rim portions, and
in an outer surface of each of the projected portions on the outer peripheral side of the retaining portion, at least a portion on a distal end side in a projected direction is located radially inward of the outer peripheral surface of each of the rim portions.

2. The radial roller bearing cage according to claim 1, wherein the entire outer surface of each of the projected portions on the outer peripheral side of the retaining portion is located radially inward of the outer peripheral surface of each of the rim portions.

3. The radial roller bearing cage according to claim 2, wherein:
in the outer surface of the body portion on the outer peripheral side of the retaining portion, a partial region in a center portion in a width direction has the same diameter as the diameter of the outer peripheral surface of each of the rim portions; and
in the outer surface of the body portion, a portion that is positioned between the partial region and the outer surface of each of the projected portions is located radially inward of the outer peripheral surface of each of the rim portions.
